(19) United States
(12) Patent Application Publication
(10) Pub. No.: US 2009/0094898 A1
(43) Pub. Date: Apr. 16, 2009

(54) Assembly of Cam-actuated Brake in Locking Shoe for Tilt Sash

(75) Inventors: Mark R. Baker, Rochester, NY (US); Jeffrey Tuller, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 11/872,293

(22) Filed: Oct. 15, 2007

(51) Int. Cl. E05D 7/00

(52) U.S. Cl. 49/181

(57) ABSTRACT

An assembly of a cam and a tilt lock in a shoe for a tilt sash includes retainer tabs disposed near the cam to trap movable brake pads between the tabs and a shoe wall so that the brake pads can move apart in response to pivoting of the cam to a locked position and can move back toward each other to an unlocked position while remaining effectively retained by the tabs.

### TECHNICAL FIELD

Locking shoes for tilt sash.

### BACKGROUND

The invention of this application improves on an assembly of a brake or locking element in a tilt shoe that includes a cam to actuate the brake when a sash tilts. The previous assembly is illustrated and described in published U.S. patent application 2005/00229492, application Ser. No. 11/101,202, which represents the closest known prior art.

### SUMMARY

The previous lock and shoe assembly encountered difficulties when the marketplace demanded narrower lock shoes running in narrower shoe channels. The tilt shoe assembly that is the subject of this application was able to meet the demand for narrower shoes without compromising the reliability of the assembly and without adding to the cost of manufacture.

The new assembly uses brake retaining tabs that hold the brake or locking element within the shoe while allowing a pair of brake pads to expand and lock or retract and unlock. The tabs are spaced from a guide wall along which a bearing wall of the locking element moves as the brake operates. A portion of the bearing wall fits between the tabs and the guide wall to retain the locking element in place.

A tilt cam that spreads the brake pads apart when a sash tilts is disposed between the brake pads for this purpose. When the sash untilts or returns to vertical, the brake pads retract with the tilt cam. This is accomplished by a resilient element connecting the brake pads and holding them against cam surfaces.

Movement of the brake pads in response to the tilt cam does not separate the pads by enough to allow bearing walls of the locking element to escape from the retainer tabs. The resilient element, however, allows the brake pads to be spread far enough to escape, and this possibility can be used to assemble the locking element into the shoe before the shoe is arranged within a shoe channel. Thereafter, the locking element cannot escape from the shoe and yet is free and effective in its movements in response to the tilt cam to lock and unlock as the sash tilts.

### DRAWINGS

FIG. 1 is an elevational view of a preferred embodiment of the inventive assembly.

FIG. 2 is a side elevational view of the shoe of FIG. 1.

FIG. 3 is a side elevational view similar to the view of FIG. 2, with a locking element and cam removed from the shoe.

FIG. 4 is an elevational view similar to the view of FIG. 1 with the locking element and cam removed from the shoe.

FIG. 5 is a plan view of the locking element removed from the shoes of FIGS. 3 and 4.

FIG. 6 is a fragmentary cross-sectional view of the assembly of FIG. 1, taken along the line 6-6 thereof.

FIG. 7 is an exploded perspective view of the shoe and cam of FIGS. 1 and 2 showing the locking element separated from the shoe.

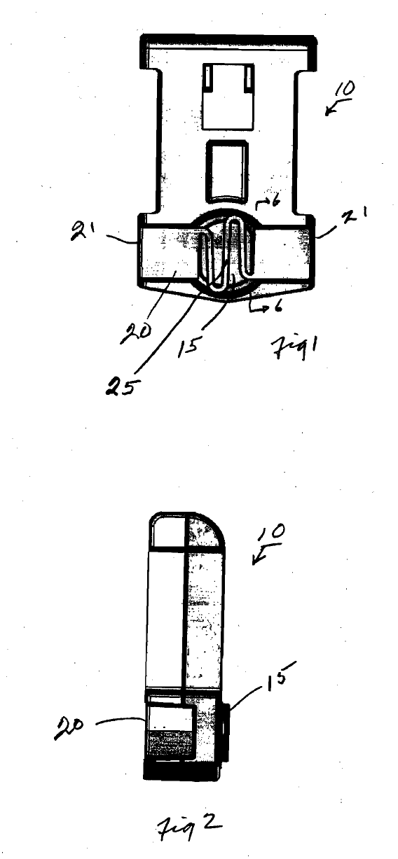

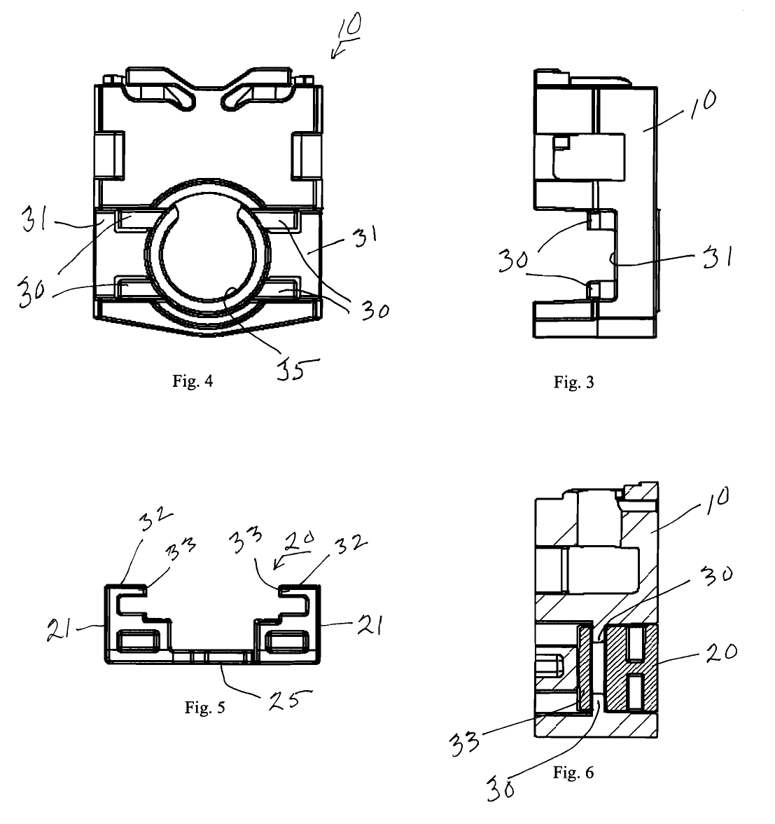

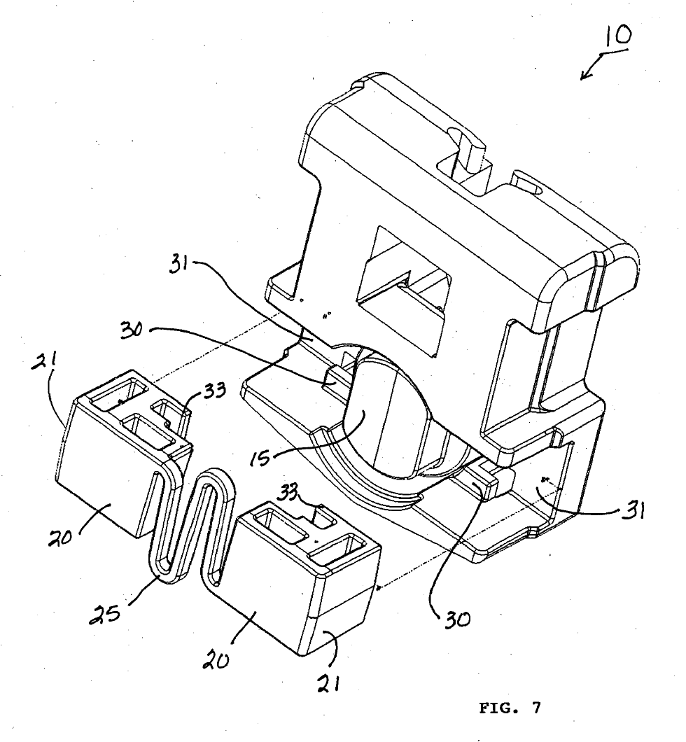

### DETAILED DESCRIPTION

Shoe 10, as shown in the drawings, can have many forms that are preferably molded of resin material and dimensioned to slide up and down within a shoe channel (not shown) of a tilt sash (also not shown). Shoe 10 connects to a counter balance that is not illustrated because it can be formed in a variety of ways to exert an upward force against shoe 10 to counterbalance a sash to which the shoe is connected. The operation of locking shoes generally is well understood in the window sash counterbalance art, and is explained in published U.S. Patent application No. 2005/00229492.

Shoe 10 contains tilt cam 15 that rotates when a sash tilts. Locking element 20 is actuated by cam 15 to lock shoe 10 within a shoe channel whenever the sash tilts. Conversely, when a sash untilts and returns to a vertical position within a window jamb, cam 15 rotates to a position releasing locking element 20 to allow shoe 10 to move freely up and down in a shoe channel as a sash moves.

Locking element 20 is formed with a pair of opposed brake pads 21 that are inter-connected by a resilient element 25, which holds brake pads 21 against surfaces of cam 15. When cam 15 rotates in response to a sash tilt, this forces brake pads 21 apart, against the resilience of element 25, to lock shoe 10 within a shoe channel. Conversely, when a sash untilts and rotates cam 15 to an unlocked position, resilient element 25 draws brake pads 21 back toward each other to release the sash brake.

The assembly of brake 21 within shoe 10 for operative movement in response to cam 15 is preferably accomplished by retainer tabs 30. These are spaced from a guide or groove wall 31, which intersects recess 35 that receives cam 15. Tabs 30, besides being spaced from guide wall 31, are preferably located adjacent cam recess 35.

Brake element 20 has a pair of bearing walls 32 that move along guide wall 31 of shoe 10 as brake 20 moves between locked and unlocked positions. Portions 33 of bearing walls 32 of brake 20 fit between retainer tabs 30 and guide wall 31 to retain brake 20 in place while it moves between locked and unlocked positions. Bearing wall portions 33 slide outward and inward while trapped behind retainer tabs 30.

Surfaces of cam 15 are configured so that they do not spread brake pads 21 far enough apart so that bearing surface portions 33 can escape from behind retainer tabs 30. This ensures that brake 20 remains assembled to shoe 10 while it moves between locked and unlocked positions.

Resilient element 25, which biases brake pads 21 toward each other and into engagement with surfaces of cam 15, does allow brake pads 21 to be spread farther apart than the locked position produced by cam 15. This can occur, however, only when shoe 10 is not confined within a shoe channel. This allows assembly and disassembly of brake element 20 and shoe 10 when shoe 10 is not confined within a jamb channel. In other words, cam 15 can never dislodge locking element 20 from its movably trapped position behind retainer tabs 30, but resilient element 25 allows brake pads 21 to be spread farther apart during assembly or disassembly of bearing wall portions 33 into retained positions behind tabs 30 when shoe 10 is not confined within a jam channel. Initial assembly of lock 20 to shoe 10 is accomplished simply by spreading brake pads 21 apart far enough to position bearing walls 32 against guide wall 31 and then allow resilient element 25 to retract brake pads 21 toward each other and move bearing wall portions 33 in behind tabs 30 where brake element 20 is permanently retained for movement between locked and unlocked positions.

The assembly of a shoe, locking element, and tilt cam, as explained above, allows shoe 10 to be made narrower than previous shoes have been made to fit in narrower shoe channels, as desired by window manufacturers. Positioning retainer tabs 30 close to cam recess 35 allows shoe 10 to retain bearing wall portions 33 effectively and operatively without requiring much shoe width.

Arranging tabs 30 to engage both upper and lower portions of bearing wall projections 33 is also preferred for secure and reliable retention of lock 20. This may not be essential in practice, however. While the preferred embodiment, as illustrated, suggests 4 retainer tabs 30, a single pair of tabs may be arranged with one retainer tab on each side of cam recess 35 to accomplish the necessary retention. Other variations are also possible in adapting shoe 10 to different counterbalance systems, and different shoe channel dimensions and configurations.

What is claimed is:

1. An assembly of a cam-actuated brake in a locking shoe for a tilt sash, the assembly comprising:
the shoe having a guide wall along which the brake moves between braked and unbraked positions in response to rotation of the cam;
the brake having a bearing wall engaging the guide wall as the brake moves between the braked and unbraked positions;
brake retainer tabs spaced from the guide wall; and
a portion of the bearing wall of the brake being disposed between the tabs and the guide wall so that the tabs retain the brake in the shoe while allowing the brake to move between the braked and unbraked positions.

2. The assembly of claim 1 wherein the retainer tabs are arranged adjacent a cam recess in the shoe.

3. The assembly of claim 1 wherein the brake includes a pair of brake pads disposed on opposite sides of the cam, and a resilient interconnector of the pads holds the pads against the cam.

4. The assembly of claim 3 wherein the resilient interconnector allows the brake pads to spread far enough apart for the pads to escape from the retainer tabs when the shoe is not confined within a shoe channel.

5. The assembly of claim 1 wherein the retainer tabs engage upper and lower edges of the bearing wall.

6. An assembly of a cam and a tilt lock in a shoe for a tilt sash, the assembly comprising:
retainer tabs disposed adjacent a shoe recess receiving the cam, the tabs being spaced from a transverse shoe wall intersecting the recess;
the tilt lock having brake pads disposed on opposite sides of the cam;
the brake pads having walls movably trapped between the retainer tabs and the shoe wall;
a resilient element interconnecting the brake pads and operatively holding the brake pads against the cam; and
the resilient element allowing the brake pads to spread apart widely enough to escape from the retainer tabs when the shoe is not confined within a shoe channel.

7. The assembly of claim 6 wherein the cam does not spread the brake pads apart by enough to escape from the retainer tabs.

8. The assembly of claim 6 wherein the retainer tabs include a pair of upper and lower retainer tabs on each opposite side of the recess.

9. The assembly of claim 8 wherein the retainer tabs engage upper and lower edges of the brake pad walls.

10. A retainer system holding a tilt lock in a sash shoe, the retainer system comprising:
a guide wall disposed in the shoe to guide movement of the tilt lock between locked and unlocked positions;
the tilt lock having a pair of bearing walls that move along the guide wall as the tilt lock moves between braked and unbraked positions;
retainer tabs spaced from the guide wall and positioned near upper and lower edges of the guide wall; and
portions of the bearing walls of the tilt lock being configured to fit between the retainer tabs and the guide wall to retain the tilt lock as it moves between the locked and unlocked positions.

11. The system of claim 10 wherein the pair of bearing walls are arranged on opposite sides of a tilt cam disposed in the sash shoe.

12. The system of claim 10 wherein the tilt lock has a pair of brake pads carried respectively by the pair of bearing walls.

13. The system of claim 12 wherein the tilt lock has a resilient element interconnecting the brake pads to hold the brake pads against a tilt cam.

14. The system of claim 10 wherein the retainer tabs are disposed adjacent the tilt cam.
